(19) United States
(12) Patent Application Publication
(10) Pub. No.: US 2021/0105883 A1
(43) Pub. Date: Apr. 8, 2021

(54) WARM DIMMING SECURITY LIGHT SYSTEM

(71) Applicant: Christine Ironfield, San Francisco, CA (US)

(72) Inventor: Christine Ironfield, San Francisco, CA (US)

(21) Appl. No.: 16/930,006

(22) Filed: Jul. 15, 2020

Related U.S. Application Data
(63) Continuation of application No. 62/909,735, filed on Oct. 2, 2019.

(51) Int. Cl. H05B 47/115; F21V 23/00; F21V 23/04; F21S 8/00; F21V 31/00; H05B 45/20; H05B 47/16

(52) U.S. Cl. CPC H05B 47/115; F21V 23/003; F21V 23/0471; F21Y 2115/10; F21V 31/00; H05B 45/20; H05B 47/16; F21S 8/033

(57) ABSTRACT

Systems and methods for LED lighting, such as systems and methods of use of a warm dimming security light. In one embodiment, the warm dimming security light smoothly changes a security light between selectable configurations, such as those defining light temperature and light distribution pattern. In one aspect, the warm dimming security light changes a security light from a dim warm white look to bright cool white flood light, as triggered by an occupancy or proximity sensor.

### CROSS-REFERENCE TO RELATED APPLICATION

This application is a nonprovisional patent application of and claims the benefit of U.S. Provisional Patent Application No. 62/909,735, filed Oct. 2, 2019 and titled “Warm Dimming Security Light,” the disclosure of which is hereby incorporated herein by reference in its entirety.

### FIELD

The disclosure relates generally to systems and methods involving light emitting diodes (LED) lighting, and specifically to systems and methods of use of a warm dimming security light.

### BACKGROUND

Conventional security lighting systems operate with white light and either dim the white light or toggle the white light between on and off positions. Such systems may be triggered by a proximity sensor or motion detection sensor. Some other conventional security systems operate with audio and/or visual sensors which record activity within designated zones based on a proximity sensor or a motion detection sensor.

In U.S. Pat. No. 9,648,688 to Beausoleil, a conventional security lighting system is described. A set of light fixtures are planted in the ground and may emit white light or infrared light. The intensity of the lights may be manually controlled by an operator using a light intensity controller. The configuration of the lights is not a function of the presence or proximity of an object, such as a person, within a designated zone. U.S. Pat. No. 9,648,688 to Beausoleil is incorporated by reference in entirety for all purposes. Other conventional security lighting systems are described in, for example, U.S. Pat. No. 9,939,136 to Vidal; U.S. Pat. No. 9,903,576 to Cree; and U.S. Pat. No. 10,129,957 to Chen; and U.S. Pat. Appl. No. 2018/0123340 to McClellan, all of which are incorporated by reference in entirety for all purposes.

In U.S. Pat. Appl. No. 2018/0114421 to Siminoff, a conventional security monitoring system is described. A set of intrusion zones are defined and monitored by a set of cameras. Motion within an intrusion zone, as detected by motion sensors, triggers recording by one or more of the cameras. No lighting element is described in the Siminoff system. U.S. Pat. Appl. No. 2018/0114421 to Siminoff is incorporated by reference in entirety for all purposes. Other conventional security monitoring systems are described in, for example, U.S. Pat. No. 10,284,792 to Siminoff and U.S. Pat. No. 10,497,236 to Lemberger; and U.S. Pat. Appl. Nos. 2018/0232895 to Modestine; 2018/0293863 to Tavares; 2018/0176512 to Siminoff; and 2018/0308328 to Siminoff, all of which are incorporated by reference in entirety for all purposes.

What is needed is a system and method of use to smoothly change a security light between selectable configurations, such as those defining light temperature and light distribution pattern.

The disclosure solves this need by providing a lighting system that smoothly changes a security light between selectable configurations, such as between a dim warm white look to bright cool white flood light, via an occupancy or proximity sensor. In one aspect, unique dynamic white lighting techniques and DTM technology are employed to leverage efficient variable cool to warm white dim curves that may be accessed at any point on the curve to reproduce the desired lighting color temperature and intensity with repeatable results.

### SUMMARY

Systems and methods for LED lighting, such as systems and methods of use of a warm dimming security light, are disclosed. In one embodiment, the warm dimming security light smoothly changes a security light between selectable configurations, such as those defining light temperature and light distribution pattern. In one aspect, the warm dimming security light changes a security light from a dim warm white look to bright cool white flood light, as triggered by an occupancy or proximity sensor.

In one embodiment, a warm dimming security light system is disclosed, the system comprising: one or more sensors detecting an object within a security perimeter and measuring a distance to the object; at least one LED light comprising a first LED light, the first LED light configured to operate in a particular first LED light configuration state of a set of first LED light configuration states; a dimming controller having a system dimming schedule and receiving the distance to the object from the one or more sensors; wherein: the dimming schedule relates a set of distances to the set of first LED light configuration states; the dimming controller determines the particular first LED light configuration state based at least on the distance and the system dimming schedule; the dimming controller transmits the particular first LED light configuration state to the first LED light; and the first LED light operates in the particular first LED light configuration state.

In one aspect, the set of first LED light configuration states are defined at least by a set of first LED light temperature values of the first LED light. In another aspect, the set of first LED light configuration states are further defined by a set of first LED light distribution patterns of the first LED light. In another aspect, the set of first LED light temperature values comprise a dim warm white temperature value and a bright cool white temperature value. In another aspect, the first LED light is one of: a two channel LED light and a four channel LED light. In another aspect, the first LED light is a multiple colored LED. In another aspect, the dimming controller is a DTM. In another aspect, the at least one sensor comprises a proximity sensor operating to measure the distance to the object. In another aspect, the first LED light is an LED flood light. In another aspect, the system further comprises a watertight power supply providing electrical power to the first LED light.

In another embodiment, a method of using a warm dimming security light system is disclosed, the method comprising: providing a warm dimming security light system comprising: one or more sensors operating to detect an object within a security perimeter and measure a distance to the object; at least one LED light comprising a first LED light, the first LED light configured to operate in a particular first LED light configuration state of a set of first LED light configuration states; and a dimming controller having a system dimming schedule and operating to receive the distance from the one or more sensors, the dimming schedule relating a set of distances to the set of first LED light configuration states; defining a security perimeter; detecting, by the sensor, an object within the security perimeter; measuring, by the sensor, a distance to the object; determining the particular first LED light configuration state based at least on the distance and the system dimming schedule; transmitting, by the dimming controller, the particular first LED light configuration state to the first LED light; and operating the first LED light in the particular first LED light configuration state.

In one aspect, the set of first LED light configuration states are defined at least by a set of first LED light temperature values of the first LED light. In another aspect, the set of first LED light configuration states are further defined by a set of first LED light distribution patterns of the first LED light. In another aspect, the set of first LED light temperature values comprise a dim warm white temperature value and a bright cool white temperature value. In another aspect, the first LED light is one of: a two channel LED light and a four channel LED light. In another aspect, the first LED light is a multiple colored LED light. In another aspect, the dimming controller is a DTM and the at least one sensor is a proximity sensor measuring the distance to the object. In another aspect, the method further comprises a watertight power supply providing electrical power to the first LED light. In another aspect, the first LED light is an LED flood light.

In yet another embodiment, a warm dimming security light system is disclosed, the system comprising: a proximity sensor detecting an object within a security perimeter and measuring a distance to the object; a first LED light configured to operate in a particular first LED light configuration state of a set of first LED light configuration states; a DTM having a system dimming schedule and receiving the distance to the object from the one or more sensors; wherein: the dimming schedule relates a set of distances to the set of first LED light configuration states; the dimming controller determines the particular first LED light configuration state based at least on the distance and the system dimming schedule; the set of first LED light configuration states are defined at least by: a set of first LED light temperature values of the first LED light, and a set of first LED light distribution patterns of the first LED light; the DTM transmits the particular first LED light configuration state to the first LED light; and the first LED light operates in the particular first LED light configuration state.

By way of providing additional background, context, and to further satisfy the written description requirements of 35 U.S.C. § 112, the following references are incorporated by reference in their entireties (all to Hanslip): U.S. Pat. Nos. 9,797,583; 10,111,294; 10,383,189; 10,378,747; and 10,663,156; and U.S. patent application Ser. Nos. 16/882,583; 16/537,285; 16/509,173; 16/912,829; and 62/909,964.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a representation of a security lighting system of the prior art;

FIG. 2 is a representation of perimeter monitoring zones of a camera-based security system of the prior art;

FIG. 3 is a schematic diagram of one embodiment of a warm dimming security light system of the disclosure;

FIG. 4A is a representation of the warm dimming security light system of FIG. 3 operating in a first configuration wherein an object is outside of a security perimeter;

FIG. 4B is a representation of the warm dimming security light system of FIG. 3 operating in a second configuration wherein an object is inside of a security perimeter;

FIG. 4C is a representation of the warm dimming security light system of FIG. 3 operating in a third configuration wherein an object is inside of a security perimeter;

FIG. 5A is a dimming schedule relating distance to detected object with LED temperature output of the warm dimming security light system of FIG. 3;

FIG. 5B is a dimming schedule relating distance to detected object with LED light distribution pattern of the warm dimming security light system of FIG. 3;

FIG. 6 is a schematic diagram of one embodiment of a dimming controller used as an element of the warm dimming security light system of FIG. 3; and

FIG. 7 is a flow diagram of one method of using the warm dimming security light system of FIG. 3.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

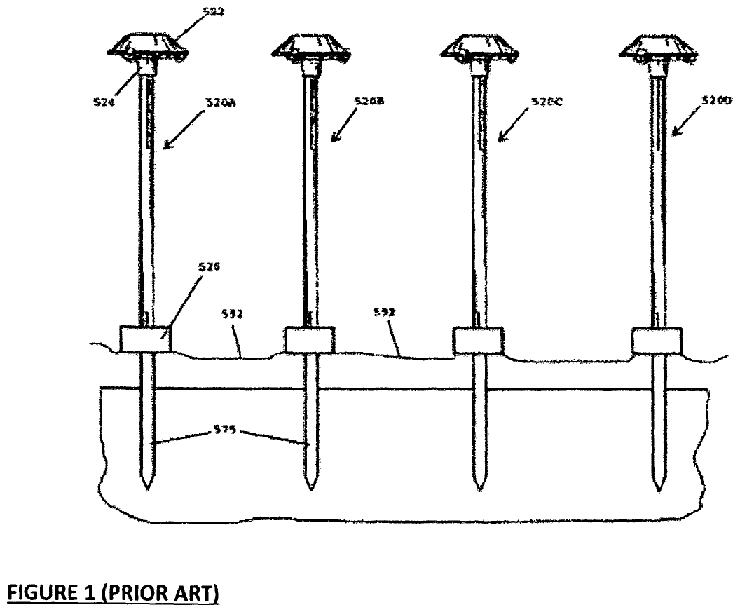

The disclosed devices, systems, and methods of use will be described with reference to FIGS. 1-7. Generally, systems and methods involving light emitting diodes (LED) lighting, and specifically to systems and methods of use of a warm dimming security light system, are disclosed.

FIG. 1 presents a conventional security lighting system of the prior art. Specifically, a conventional security lighting system of U.S. Pat. No. 9,648,688 to Beausoleil is depicted. A set of four light fixtures are planted in the ground and emit white light or infrared light. The intensity of the lights may be manually controlled by an operator using a light intensity controller. The configuration of the lights is not a function of the presence or proximity of an object, such as a person, within a designated zone.

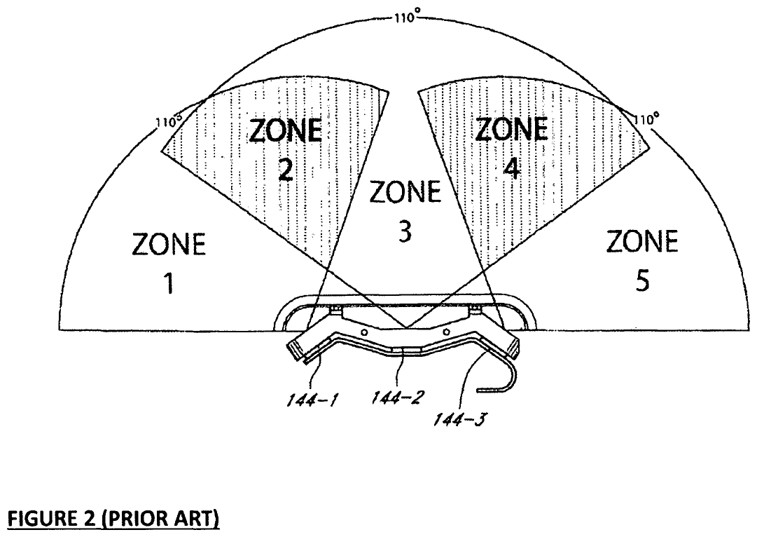

FIG. 2 presents a conventional security monitoring system of the prior art. Specifically, a conventional security monitoring system of U.S. Pat. Appl. No. 2018/0114421 to Siminoff is depicted. A set of five intrusion zones are defined and monitored by a set of three cameras. Motion within an intrusion zone, as detected by motion sensors, triggers recording by one or more of the cameras. No lighting element is described in the Siminoff system.

The disclosure provides a warm dimming security light that may smoothly change a security light between selectable configurations, such as those defining light temperature and light distribution pattern, as triggered by the presence of an object within a defined security zone. In one aspect, the warm dimming security light changes a security light from a dim warm white look to bright cool white flood light, as triggered by an occupancy or proximity sensor.

In another aspect, unique dynamic white lighting techniques and DTM technology are employed to leverage efficient variable cool to warm white dim curves that may be accessed at any point on the curve to reproduce the desired lighting color temperature and intensity with repeatable results.

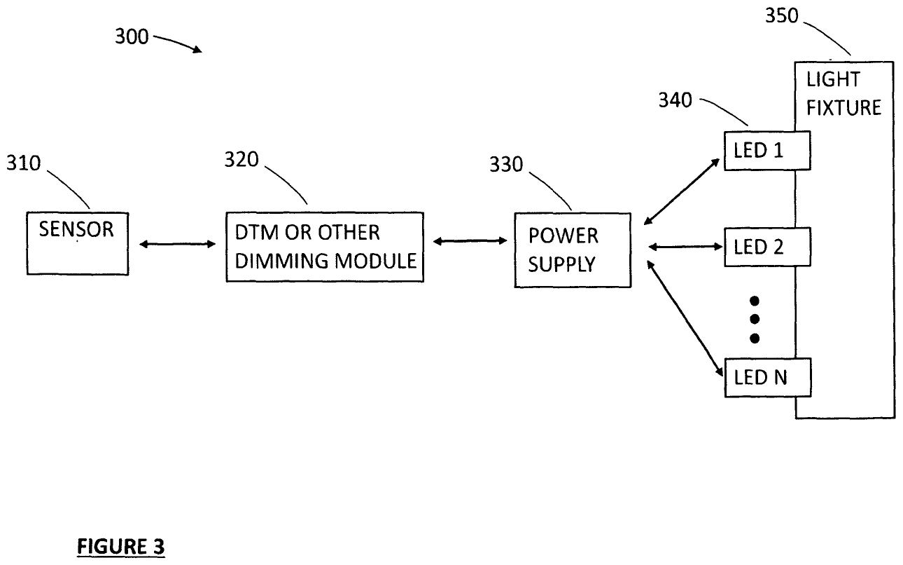

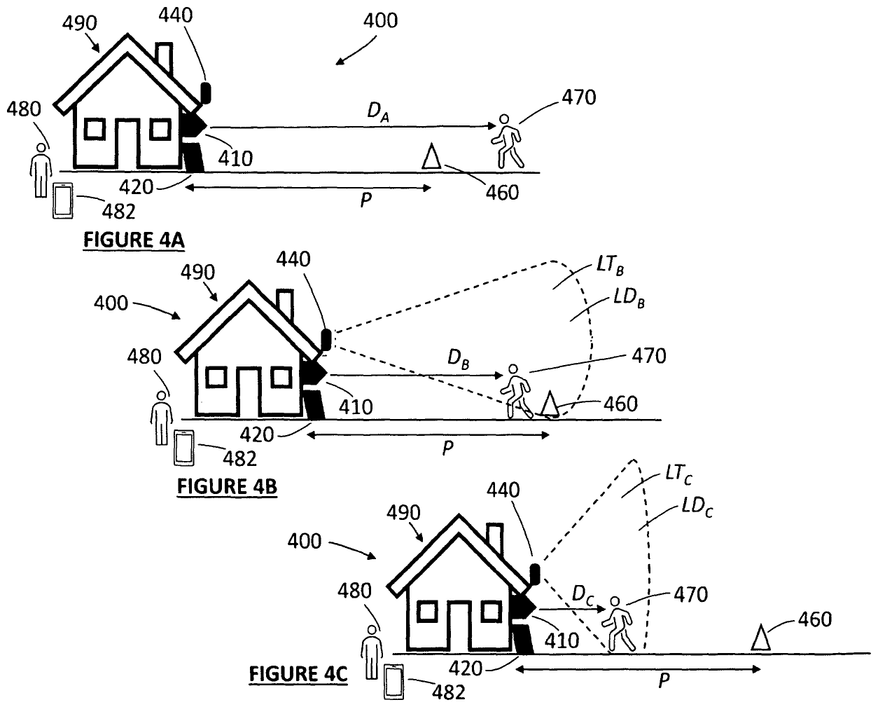

With attention to FIGS. 3 and 4A-C, a warm dimming security light system (the “lighting system” or the “system”) 300, 400 respectively is depicted. The lighting system 300 comprises one or more sensors 310, a DTM (“dynamic tuner module”) or other dimming control module 320 (also referred to as a “dimming controller” or simply a “controller”), a power supply 330, one or LEDs 340, and a lighting fixture 350. In one embodiment, the lighting fixture 350 is not a part of the lighting system 100. In some embodiments, the one or more LEDs 340 may comprise other than LED lights, e.g. a halogen lamp and other lights known to those skilled in the art. In some embodiments, each LED 340 may be engaged with a separate lighting fixture 350. In some embodiments, one or more LEDs 340 may be driven or controlled by a separate driver (not shown), the separate drivers in communication with the DTM controller 320.

Generally, the warm dimming security light system 300 smoothly changes one or more LED lights 340 according to a selectable set of LED configuration states, the states defined by, e.g., LED light temperature values, LED light distribution patterns, and other LED characteristics as known to those skilled in the art. For example, the set of LED lights may change from a dim warm white look to bright cool white flood light as triggered by the presence of an object within a defined security perimeter and as determined based on the distance to the object from the sensor 310. (As described with below with respect to, e.g., FIGS. 4A-B and 5A-B.)

The one or more sensors 310 may comprise a proximity or occupancy sensor which is triggered or senses an object, such as a person, at a selectable distance from the sensor 310, and/or senses an object, such as a person, is positioned at a selectable location. For example, the sensor 310 may trigger or sense or measure when an object is 10 m or less from the sensor, and/or when an object is occupying a selected position or location such as a front door of a residence. The sensor 310 may also trigger upon movement at a selected location, such as movement within a defined area surrounding a car parked near a residence or business.

The DTM or other dimming module (the “DTM”) 320 receives sensor data from the one or more sensors 310 and creates or controls dimming of one or more LEDs 340. For example, in one embodiment, the DTM 320 controls or drives a configurable dynamic LED white light 340 so as to smoothly change the light 340 from a dim warm white look to a bright cool white flood light. Other dimming control schemes are possible. For example, the DTM 320 may adjust or control or drive one or more LEDs 340 per any provided “dim curve” to include dim curves provided by way of, e.g., externally-provided dim curves, electronic input such as by way of an app and/or a smart phone, and the like. More details of the control of LED light configuration states is provided below, e.g. with respect to FIGS. 4A-C and 5A-C.

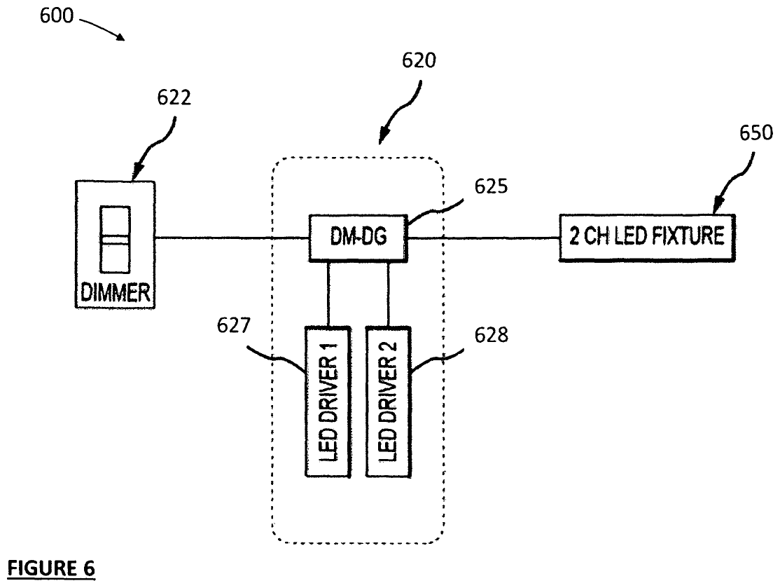

The DTM 320 is a network device that can communicate with lighting controls and fixtures via a network router. DTM 320 may also link to an iOS or Android-type device over WI-FI or blue tooth, putting the power to configure, control and customize intensity, color and color temperature of white lighting usable at a user device, such as a smartphone. Thus, the DTM 320 may simplify and automate the process of creating the warm-dimming effect by storing multi-channel dim curves on a microprocessor and memory (not shown) that may store the dim curves (and other selectable characteristics of the one or more LED lights 340) and can be activated by a standard wall box dimmer (622 in FIG. 6, as discussed below). The microprocessor may be a part of the DTM or a driver. This driver simplifies wiring, installation and saves cost and eliminates the DMX and DMX drivers required with a conventional DTM solution. This may also allow the controller 320 to communicate directly with any drivers associated with the one or more LEDs 340, and provide the functionality to receive the binary communication from the third party control, and change and or augment the communication to change the control information and thereby change the functionality of the drivers of the one or more LEDs 340.

Power supply 330 provides power to one or more LEDs 340, DTM 330, and/or sensors 310. In one embodiment, the power supply 330 is a direct burial solid state power supply as described in U.S. Pat. Appl. No. 62/909,964 to Hanslip filed Oct. 3, 2019 and incorporated by reference in entirety for all purposes.

The one or more LEDs 340 may be, in various embodiments, any combination of round or linear, 2 or 4 channel LED lights, with multiple colored diodes. In an example, fixtures 350 may include a red, green, blue, and white LED source or module.

The one or more LEDs 340 may be coupled with or be disposed on a light fixture 350. In one embodiment, the light fixture 350 forms at least a part of a security system light fixture, such as mounted on business or residential structures. The light fixture 350 may be any light fixture known to those skilled in the art, to include light fixtures used in security applications.

The user device 482 may be configured with one or more applications (the “app”), such as an iOS application, that engages with the DTM controller 320. The app allows for network triggers to be created on the Dynamic Tuner Module 320 so that it can listen for network traffic on specific ports and/or IP addresses with specific strings. Depending on the received string, it can perform simple commands, such as activating a specified preset. Network triggers are particularly useful so that third party devices can issue commands that Dynamic Tuner Module 320 responds to in the same way that it responds to the app's simple commands.

On setup completion, the app's home screen is displayed on the user device 482 with buttons that mirror the layout of button wall panels used in similar systems. Each button can be edited to write a custom preset functionality to the Dynamic Tuner Module 320 from the app that can be operated later without the use of the app. Once the preset is defined and saved to the Dynamic Tuner Module 320, only simple commands are needed from the app, wall panel, or network trigger to activate the complex logic that manages button presets.

All of the independent and integrated functionality is created from within the app so that it can configure Dynamic Tuner Module 320 to listen to third party commands, manage dimming, dim level recall, active sundial states, active color, and cycle speeds behind the various preset modes. Another configuration of DTM controller components is provided as FIG. 6, described in more detail below.

The system includes software interface as well as the LED systems and associated dimming levels and methods utilized to create full-spectrum color-tuning lighting systems that can reproduce accurate, high quality lighting.

A communication network (not shown) connects the elements of the system 300, and may include the Internet, cellular, Wi-Fi, blue-tooth, satellite, radio frequency (RF), or any other form of wires or wireless communication network between, e.g. fixtures 350, LED control drivers (not shown) controlling the fixtures and/or LED lights 340, controller 320, sensor 310, and remote user device (e.g. element 482 in FIGS. 4A-C) which may control or otherwise engage with system 300 elements, such as controller 320, and may include cloud-type programs and devices. User device(s) 482 may include smart phones, tablets, or any other device capable of sending and receiving information to the various elements of system 300. The information may include information associated with lighting control, configuration information, and information about the system elements, to include particular configurations of the one or more LED lights 340, the security perimeter definition (e.g. the distance P in FIGS. 4A-C described below), or other information. The communication between system 300 elements may be wired or wireless.

With attention to FIGS. 4A-C, a warm dimming security light system 400 is depicted in an operational scenario. The lighting system 400 is similar in components to that of system 300, and comprises a sensor 410, a dimming control module 420 (also referred to as a “dimming controller” or simply a “controller”), and an LED 440. A power supply is not depicted for clarity.

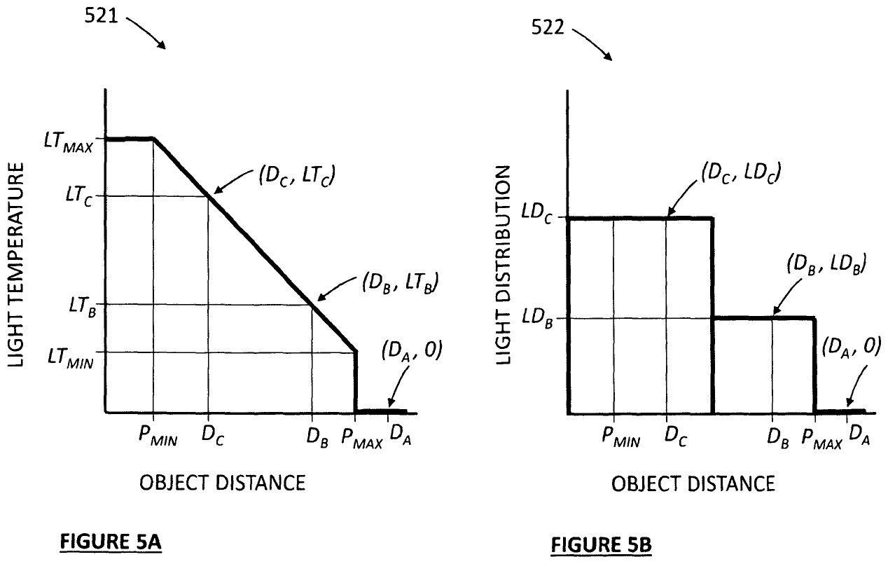

Generally, the system 400 monitors a defined and selectable security perimeter which, when breached, triggers operation of an LED according to a defined and selectable set of LED light configuration states, such states determined by the distance to the detected object. FIGS. 4A-C depict three states or modes of the system 400 as function of three positions of an object (here, an intruder person 470). FIGS. 5A-B depict two types of light configuration types (light temperature and light distribution) as functions of distance to an object, with reference to the three scenarios of FIGS. 4A-C.

In each of FIGS. 4A-C, an intruder person 470 is depicted approaching a residential structure 490 with a defined security perimeter, the security perimeter depicted with linear distance P ending at pylon 460. The system 400 is engaged with a user 480 and a user device 480, the user device 482 operating to engage the controller 420. The user 480, by way of user 482 and the app(s) as described above, may select and/or define LED light configuration states as a function of intruder 470 states, such as distance of intruder 470 to sensor 410. The LED light configuration states may be defined in any of several ways, such as the definitions provided in FIGS. 5A-B described below.

In FIG. 4A, the intruder 470 is at a distance of D_{A}, the distance D_{A} greater than the security perimeter as defined by distance P. As such, no activation of the LED light 440 is triggered. This state of the system 400 is depicted as data point (D_{A}, 0) in each of FIGS. 5A and 5B.

In FIG. 4B, the intruder 470 is at a distance of D_{B}, the distance DB less than the security perimeter as defined by distance P. As such, activation of the LED light 440 is triggered. This state of the system 400 is depicted as data point (D_{B}, LTB) in FIG. 5A and as data point (D_{B}, LD_{B}) in FIG. 5B. Activation of LED light 440 at this particular light configuration state results in a light color LT_{B} of LED light 440 and light distribution LD_{B} of LED light 440.

In FIG. 4C, the intruder 470, after continuing to move toward residential structure 490, is now at a distance of D_{C}, the distance D_{C} remaining less than the security perimeter as defined by distance P. As such, activation of the LED light 440 remains triggered. This state of the system 400 is depicted as data point (D_{C}, LT_{C}) in FIG. 5A and as data point (D_{C}, LD_{C}) in FIG. 5C. Activation of LED light 440 at this particular light configuration state results in a light color LT_{C} of LED light 440 and light distribution LD_{C} of LED light 440.

Note that FIGS. 4A-C depict a simplified scenario for clarity. For example, the boundary of the security zone to by monitored by the system 400 is defined by a single parameter P. Other more complex security zones may be defined, such as those varying in distance from a sensor when looked at from above. For example, a top-down view of the security zone could be similar to that of FIG. 2 of the prior art, an egg-shaped zone, a triangularly shaped zone, etc. Also, other configurations of the system 400 are possible, to include multiple LED lights 440 positioned at a variety of locations to include on, adjacent, or near the resident structure 490, and multiple sensors 410 positioned at a variety of locations to include on, adjacent, or near the resident structure 490.

With attention to FIGS. 5A-B, a set of sample graphs of LED light configuration states are depicted. In FIG. 5A, a graph of LED light temperature with distance to an object is presented. In FIG. 5B, a graph of LED light distribution with distance to an object is presented. Other types of LED light configuration states may be provided, as known to those skilled in the art. For example, one or more LEDs may be color tuned as a function of object distance within a monitored security area. Stated another way, each LED light temperature is color tuned at full output versus the warm dimming schemes described. Such a color tuning approach provides, among other things, increased visibility when the LED operates in the warmer ranges. As another example, colored lights may be provided which allow, for example, a siren effect to be created.

An LED light is shown to operate (in each of FIGS. 5A and 5B) when an object is within the security perimeter range of 0 to P_{MAX}, where 0 distance is defined as the sensor 410 location. An object outside of P_{MAX}, meaning an object beyond the monitored security perimeter P, results in no operation of the LED light 440 (meaning the LED light 440 is off and emits no light). In contrast, an object detected by the sensor 410 that is with the security perimeter, meaning less than P_{MAX}, triggers operation of the LED light 440, meaning the LED light 440 emits light.

FIG. 5A describes a set of LED light configuration states that vary with distance of an object (from sensor 410). Specifically, the “dimming curve” 521 of FIG. 5A depicts a linear relationship of light temperature of a single LED light 440 as a function of object distance. The linear curve moves from LT_{MIN} to LT_{MAX} as an object (e.g. the intruder 470) moves from a distance P_{MAX} from sensor 410 to a distance P_{MIN} from sensor 410. As an example, LT_{MIN} could be set to emit light of a dim warm white (e.g. at or below 3000K) and LT_{MAX} could be set as to emit light of a bright cool white (e.g. 4100-5000K). Stated another way, the closer an object gets to the sensor (and to the LED light), the brighter and cooler the emitted light, and the further an object gets, the warmer and dimmer, proportionally, the emitted light provides.

Such settings for each of LT_{MIN} and LT_{MAX} may be selectable by user 480 by way of device 482 and the app described above. Other settings of LT_{MIN} and LT_{MAX} are possible, as known to those skilled in the art.

In one embodiment, the dimming curve of FIG. 5A is provided by a third party and may be input directly to the controller 320 and/or received and transmitted by an app operated on the user device 482.

In one embodiment, the dimming curve of FIG. 5A is other than linear, e.g. a polynomial curve.

In one embodiment, the system 400 comprises more than one LED light 410, such that dimming curve is a composite curve created through operation of more than one LED light 410. For example, the dimming curve of U.S. Pat. No. 10,111,294 to Hanslip may be used.

FIG. 5B describes a set of LED light configuration states that vary with distance of an object (from sensor 410). Specifically, the step curves 522 of FIG. 5B depict a modular set of two light distribution patterns of a single LED light 440 as a function of object distance. The linear curve moves from LD_{B} to LD_{C} as an object (e.g. the intruder 470) moves from a distance P_{MAX} from sensor 410 to a distance P_{MIN} from sensor 410.

The phrase “light distribution” means to the projected pattern of emitted light, such as onto a surface. A side-view of a particular light distribution is termed a “light profile.” Light distribution types are known to those skilled in the art, to include those defined by trade groups such as the Illumination Engineering Society of North America (IESNA) and the National Electrical Manufacturers Association (NEMA). In FIG. 5B, a set of two light distribution types are presented: a type LD_{B} and a type LD_{C}. For example, type LD_{C} may be of a search light character and type LD_{B} may be of a flood light character. Other settings of LD_{B} and LD_{C} are possible, as known to those skilled in the art. Also, the number of light distribution types may be other than the two shown in FIG. 5B, such as configurations of 3, 4, 5, etc. light distribution types. Furthermore, a system 400 comprising more than one LED light 440 may combine light configuration values, such as the configurations depicted in FIGS. 5A-B and others known to those skilled in the art, to produce composite or blended light emission scenarios or configurations.

FIG. 6 depicts a particular configuration of some elements of a warm dimming security light system, such as those of FIGS. 3-4. The DTM 620 comprises a dimming module 625 and two LED Driver1 627 and LED Driver2 628. The dimming module 625 may store one or more dim curves, to include those of third parties. In one embodiment, the LED Driver 1 is a cool LED and the LED Driver2 is a warm LED, and the DTM 620 includes no DMX and thus requires no programming. The DTM 620 is configured to engage a standard dimmer 622, such as a 0-10V dimmer, and to engage a two channel LED fixture, such as a cool/warm two channel LED fixture. The system 600 thus may provide warm dim and dynamic white lighting effects.

The warm dimming security light system may be used in any number of applications, to include, for example: path lighting, security food lighting, and security camera lighting e.g. as connected to a mobile app.

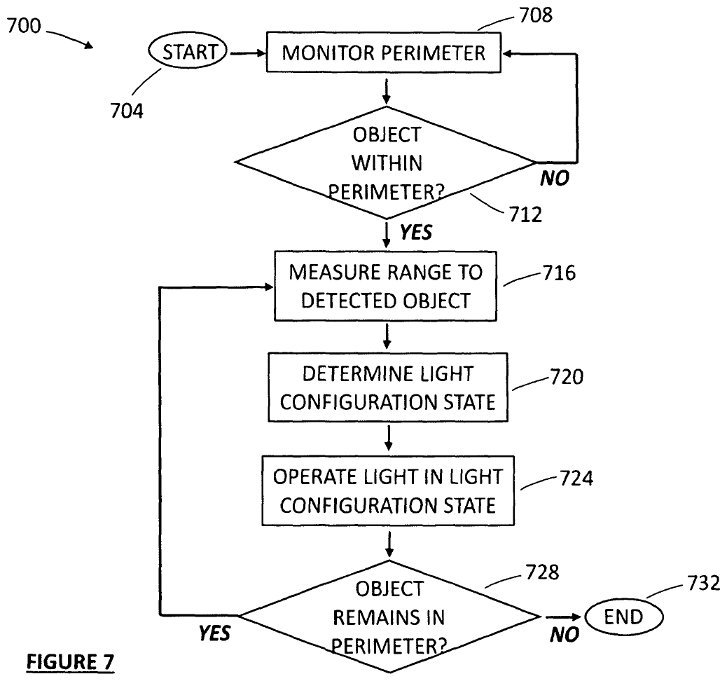

FIG. 7 provides a flow diagram of one embodiment of a method of use of the system 300, 400 described above. Generally, the method 700 starts at step 704 and ends at step 732. Any of the steps, functions, and operations discussed herein can be performed continuously and automatically. In some embodiments, one or more of the steps of the method of use 700, to include steps of the method 700, may comprise computer control, use of computer processors, and/or some level of automation. The steps are notionally followed in increasing numerical sequence, although, in some embodiments, some steps may be omitted, some steps added, and the steps may follow other than increasing numerical order. When the method references a user, the user may be one or both of one or more onsite users and one or more offsite users. A user may interact or perform one or more of the described steps be using a display/GUI as described above.

After starting at step 704, the method 700 proceeds to step 708 wherein the security perimeter is monitored. The security perimeter is as defined by user 480, for example by way of user device 482. The security perimeter may be of any defined geometry that may be monitored by the one or more sensors 310, 410. After completion of step 708, the method 700 proceeds to step 712.

At step 712, a query is made as to if any detected object is within the defined security perimeter. With reference to FIGS. 4A-C, the query is whether intruder 470 is with the perimeter P, meaning within a distance P_{MAX}. If the response to the query is NO, the method 700 proceeds to step 708. If the response to the query is YES, the method 700 proceeds to step 716.

At step 716, the method 700 measures, by way of sensor 310, 410, a distance or range to the detected object. With reference to FIGS. 4B-C, the distance D_{B} or DC is measured for respective scenario of FIGS. 4B and 4C. After completion of step 716, the method 700 proceeds to step 720.

At step 720, the particular configuration of the LED light is determined through one or more light configuration curves, such as those described with respect to FIGS. 5A-B. After determining the particular light configuration state, the particular light configuration state is transmitted to the LED light for operation. After completion of step 720, the method 700 proceeds to step 724.

At step 724, the LED light operates in the particular light configuration state. After completion of step 724, the method 700 proceeds to step 728, where a query is made as to whether the detected object is still within the security perimeter. If the result of the query is NO (meaning the object is not remaining within the security perimeter), the method 700 ends at step 732. If the result of the query is YES (meaning the object remains within the security perimeter), the method proceeds to step 716.

The exemplary systems and methods of this disclosure have been described in relation to systems and methods involving warm dimming security lighting. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A warm dimming security light system, the system comprising:
one or more sensors detecting an object within a security perimeter and measuring a distance to the object;
at least one LED light comprising a first LED light, the first LED light configured to operate in a particular first LED light configuration state of a set of first LED light configuration states;
a dimming controller having a system dimming schedule and receiving the distance to the object from the one or more sensors;
wherein:
the dimming schedule relates a set of distances to the set of first LED light configuration states;
the dimming controller determines the particular first LED light configuration state based at least on the distance and the system dimming schedule;
the dimming controller transmits the particular first LED light configuration state to the first LED light; and
the first LED light operates in the particular first LED light configuration state.

2. The system of claim 1, wherein the set of first LED light configuration states are defined at least by a set of first LED light temperature values of the first LED light.

3. The system of claim 2, wherein the set of first LED light configuration states are further defined by a set of first LED light distribution patterns of the first LED light.

4. The system of claim 2, wherein the set of first LED light temperature values comprise a dim warm white temperature value and a bright cool white temperature value.

5. The system of claim 1, wherein the first LED light is one of: a two channel LED light and a four channel LED light.

6. The system of claim 5, wherein the first LED light is a multiple colored LED.

7. The system of claim 1, wherein the dimming controller is a DTM.

8. The system of claim 1, wherein the at least one sensor comprises a proximity sensor operating to measure the distance to the object.

9. The system of claim 1, wherein the first LED light is an LED flood light.

10. The system of claim 1, further comprising a watertight power supply providing electrical power to the first LED light.

11. A method of using a warm dimming security light system, the method comprising:
providing a warm dimming security light system comprising:
one or more sensors operating to detect an object within a security perimeter and measure a distance to the object;
at least one LED light comprising a first LED light, the first LED light configured to operate in a particular first LED light configuration state of a set of first LED light configuration states; and
a dimming controller having a system dimming schedule and operating to receive the distance from the one or more sensors, the dimming schedule relating a set of distances to the set of first LED light configuration states;
defining a security perimeter;
detecting, by the sensor, an object within the security perimeter;
measuring, by the sensor, a distance to the object;
determining the particular first LED light configuration state based at least on the distance and the system dimming schedule;
transmitting, by the dimming controller, the particular first LED light configuration state to the first LED light; and
operating the first LED light in the particular first LED light configuration state.

12. The method of claim 11, wherein the set of first LED light configuration states are defined at least by a set of first LED light temperature values of the first LED light.

13. The method of claim 12, wherein the set of first LED light configuration states are further defined by a set of first LED light distribution patterns of the first LED light.

14. The method of claim 12, wherein the set of first LED light temperature values comprise a dim warm white temperature value and a bright cool white temperature value

15. The method of claim 11, wherein the first LED light is one of: a two channel LED light and a four channel LED light.

16. The method of claim 15, wherein the first LED light is a multiple colored LED light.

17. The method of claim 11, wherein the dimming controller is a DTM and the at least one sensor is a proximity sensor measuring the distance to the object.

18. The method of claim 11, further comprising a watertight power supply providing electrical power to the first LED light.

19. The method of claim 11, wherein the first LED light is an LED flood light.

20. A warm dimming security light system, the system comprising:
a proximity sensor detecting an object within a security perimeter and measuring a distance to the object;
a first LED light configured to operate in a particular first LED light configuration state of a set of first LED light configuration states;
a DTM having a system dimming schedule and receiving the distance to the object from the one or more sensors;
wherein:
the dimming schedule relates a set of distances to the set of first LED light configuration states;
the dimming controller determines the particular first LED light configuration state based at least on the distance and the system dimming schedule;
the set of first LED light configuration states are defined at least by: a set of first LED light temperature values of the first LED light, and a set of first LED light distribution patterns of the first LED light;
the DTM transmits the particular first LED light configuration state to the first LED light; and
the first LED light operates in the particular first LED light configuration state.
